(19) United States
(12) Patent Application Publication
(10) Pub. No.: US 2017/0071696 A1
(43) Pub. Date: Mar. 16, 2017

(54) DRILLING TOOL FOR DENTAL IMPLANT SURGERY, COMPRISING A STEPPED GUIDE

(71) Applicant: WAM, Aix-En-Provence (FR)

(72) Inventor: Matthieu SIADOUS, Le Beausset (FR)

(73) Assignee: WAM, Aix-En-Provence (FR)

(21) Appl. No.: 15/123,118

(22) PCT Filed: Feb. 27, 2015
(86) PCT No.: PCT/FR2015/050481

§ 371 Date: Sep. 1, 2016

(30) Foreign Application Priority Data
Mar. 3, 2014 (FR) 1451668

(51) Int. Cl. A61C 1/08

(52) U.S. Cl. CPC A61C 1/084

(57) ABSTRACT

A drilling tool for dental implant surgery, this tool having: a drilling head; a cylindrical mandrel rigidly connected to the head and coaxial therewith, this mandrel being able to be mounted in a pin in order to effect a rotational coupling of the drilling head to this pin; a mesio-distal guide cylinder coaxial with the drilling head, this mesio-distal guide cylinder having an external diameter (D2), called the mesio-distal guide diameter, greater than the drilling diameter (D1); a vestibulo-lingual guide cylinder coaxial with the drilling head and situated under the mesio-distal guide cylinder, this vestibulo-lingual guide cylinder having an external diameter (D3), called the vestibulo-lingual guide diameter, smaller than the mesio-distal guide diameter (D2).

The invention concerns the field of dental surgery, more precisely implant surgery (or implantology).

Implant surgery is performed to replace a missing tooth or a group of missing teeth with an implant or several implants. The aim of implant surgery is to restore the esthetics of the patient's mouth and to ensure normal functions of mastication and speech.

Implant surgery is ordinarily performed under local anesthesia. The procedure generally involves fitting an artificial tooth on an implant that is integrated in the jawbone of the patient. The implant is generally in the form of a post provided with an outer thread, which will engage directly in a hole drilled beforehand in the jawbone. Drilling the jawbone is a tricky procedure which requires a certain amount of dexterity on the part of the dental surgeon. This procedure usually involves making an incision in the gum in line with the implant site delimited by the (natural or artificial) boundary teeth. Once this incision has been made, the surgeon separates the resulting gum flaps and makes a preliminary hole of small diameter (generally of the order of 2 mm) directly in the jawbone by means of a drill bit mounted on a motorized rotary instrument. It is also possible to operate without flaps, by drilling directly through the gum.

Once the preliminary hole has been made, the surgeon proceeds to widen it by means of drill bits of increasing size, until a bore has been obtained that has a nominal diameter permitting the placement of the implant.

It is essential that the preliminary hole is made correctly, since its position and orientation dictate the position and orientation, respectively, of the implant and, therefore, of the artificial tooth.

In practice, the drill bit for forming the preliminary hole is mounted on a contra-angle, which is itself coupled to a motor. It will be appreciated that, when the preliminary hole is drilled freehand, the success of this operation depends on the precision shown by the surgeon. In particular, the surgeon has to pay attention to the mesiodistal and buccolingual positioning of the tool and to the orientation of the axis of the drill bit.

However, it is not impossible that the surgeon may make an awkward movement or that the patient may suffer a spasm, both of which can affect the correct drilling of the preliminary hole.

In order to avoid this type of incident, solutions have been proposed for guiding the drilling operation.

A first technique involves operating with the aid of a thermoformed aligner in which a counter-impression of the patient's mouth is formed, this aligner being provided with one or more perforations in line with the one or more implant sites. However, an aligner of this kind, commonly called a surgical guide, necessitates preliminary steps involving taking an impression, forming a mold, then producing the aligner. These steps are laborious and costly, which explains why most surgeons avoid them in favor of working freehand, despite the aforementioned risks.

A second technique involves operating with the aid of a guide rigidly connected to the drill bit or attached thereto, which permits mesiodistal guiding of the drill bit, the guide being positioned between two existing teeth delimiting the implant site or against a single tooth delimiting a complete gap at the end of the teeth.

Such a guide, described in the international application WO 2012/165093, is in the form of a cylinder with an external diameter greater than that of the drill bit on which it is mounted.

Although such a guide appears at first glance to represent progress in relation to the traditional technique of drilling freehand, it is not without its disadvantages.

Indeed, although the mesiodistal positioning of the drill bit is facilitated by the guide, the same cannot be said of the buccolingual positioning. This is because the presence of the guide at least partially conceals the implant site from the practitioner. At the very least, the guide casts a shadow on the implant site by being placed between the latter and the light (with which the contra-angles in most cases are equipped), and this makes it difficult to correctly assess the buccolingual positioning of the drill bit.

A first object is therefore to propose a solution for improving the positioning of the drilling tools in implant surgery. A second object is to propose a tool for implant surgery which permits not only mesiodistal guiding but also buccolingual guiding.

To this end, the invention proposes a drilling tool for dental implant surgery, this tool comprising:

- a drilling head, which extends along a main axis, this drilling head having an external diameter called the drilling diameter;

- a mandrel rigidly connected to the head and coaxial therewith, this mandrel being able to be mounted in a mandrel holder in order to induce a rotational coupling of the drilling head to this mandrel holder;

- a mesiodistal guide cylinder coaxial with the drilling head, this mesiodistal guide cylinder having an external diameter, called the mesiodistal guide diameter, greater than the drilling diameter;

- a buccolingual guide cylinder coaxial with the drilling head and situated under the mesiodistal guide cylinder, this buccolingual guide cylinder having an external diameter, called the buccolingual guide diameter, greater than the drilling diameter and smaller than or equal to the mesiodistal guide diameter.

This tool permits not only mesiodistal guiding but also buccolingual guiding, which enhances the precision (and safety) of the intervention.

Various additional features may be provided alone or in combination:

- the tool comprises a one-piece drill bit forming the drilling head and the mandrel, and the mesiodistal guide cylinder and the buccolingual guide cylinder are attached by being mounted on the drill bit;

- each cylinder is provided with a central bore for mounting it with free rotation on the drill bit;

- the tool comprises a depth stop in the form of a ring rigidly connected to the mandrel;

- at least one of the cylinders is rigidly connected to the mandrel or to the drilling head;

- the mesiodistal guide diameter is between 5 mm and 12 mm;

- the buccolingual guide diameter is between 3 mm and 6 mm;

- the mesiodistal guide cylinder has a height of between 1 mm and 20 mm;

- the buccolingual guide cylinder has a height of between 0.5 mm and 20 mm;

- at least one of the cylinders is provided with irrigation channels.

Other subjects and advantages of the invention will become clear from the following description of an embodiment with reference to the attached drawings, in which:

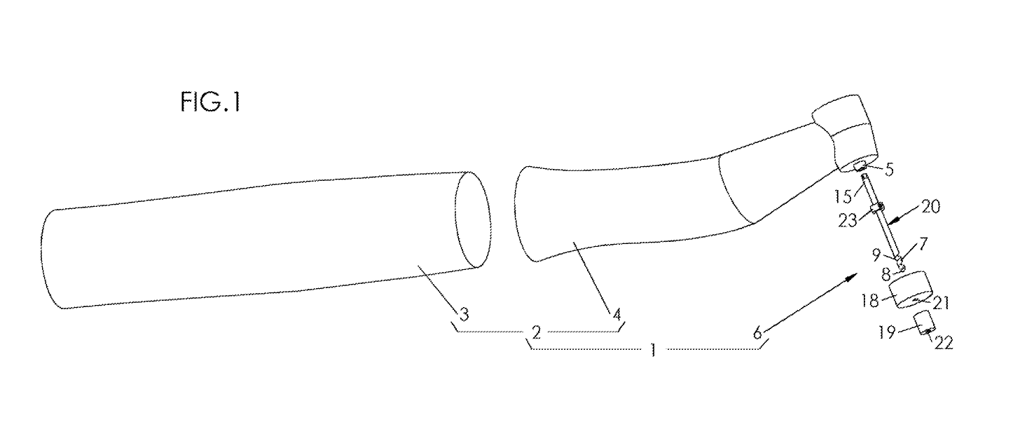

FIG. 1 is an exploded perspective view showing a drilling system used in implant surgery;

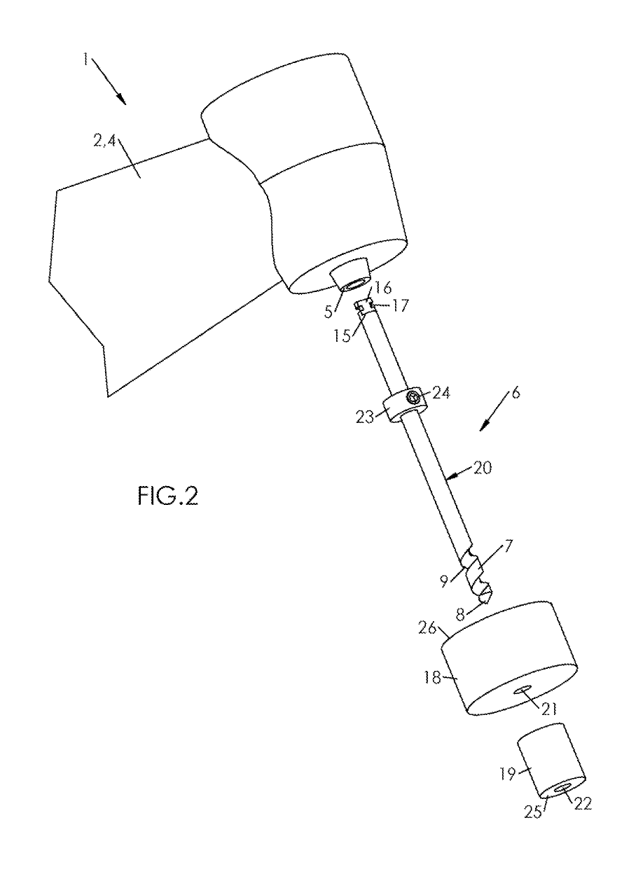

FIG. 2 is an exploded detail view of the equipment from FIG. 1;

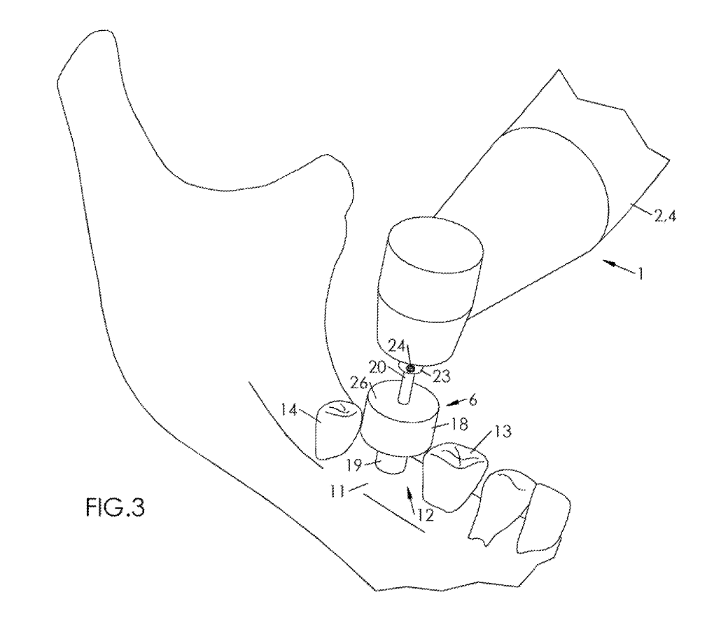

FIG. 3 is a view showing a surgical intervention using the kit from FIGS. 1 and 2;

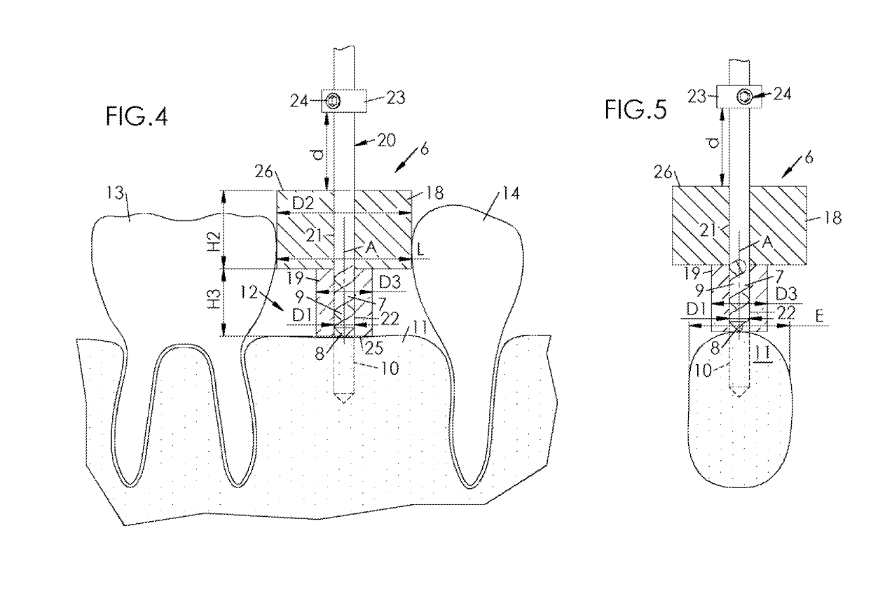

FIGS. 4 and 5 are mesiodistal and buccolingual sectional views, respectively, illustrating the placement of the drilling kit in an implant site;

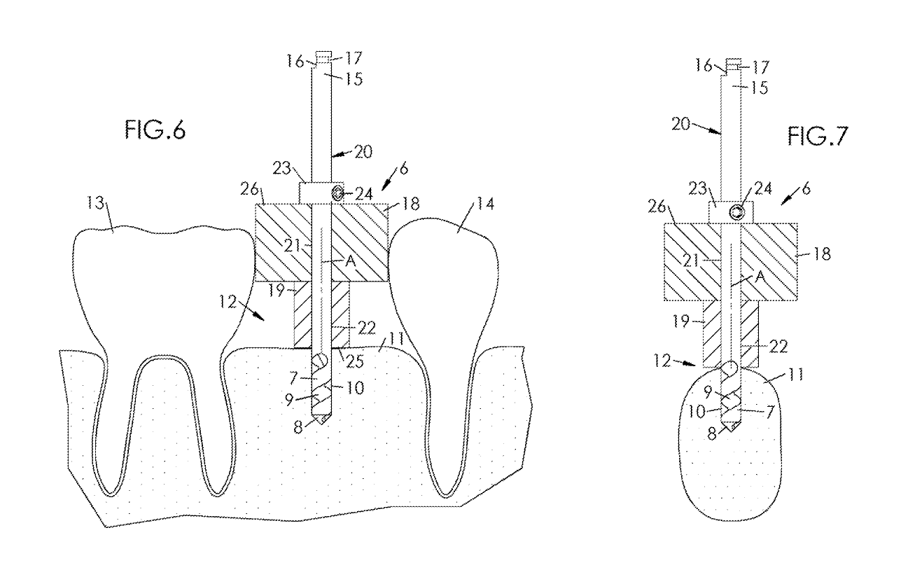

FIGS. 6 and 7 are views similar to FIGS. 4 and 5, respectively, and illustrate the drilling of a preliminary hole in the implant site;

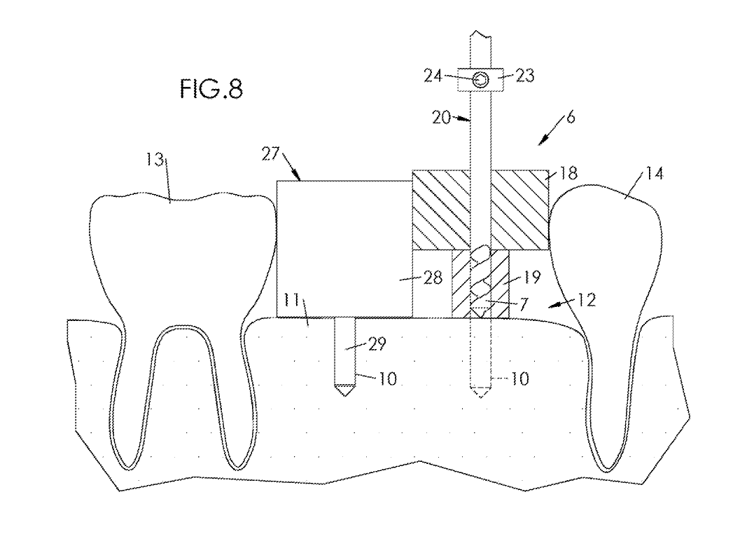

FIG. 8 is a mesiodistal sectional view illustrating a technique for drilling a series of preliminary holes.

A drilling system 1 for dental implant surgery is shown in FIG. 1. This equipment 1 comprises a surgical instrument 2 provided with a motor element 3 and with a contra-angle 4 engaged on the motor element 3 and incorporating a mandrel holder 5 for receiving a range of tools for performing drilling in a crest of a jawbone (partially visible in FIG. 3).

The system 1 moreover comprises a drilling tool 6.

The drilling tool 6 firstly comprises a drilling head 7 (which is helical in the example shown, but which can have a different shape, for example spherical) extending along a main axis A, called the drilling axis. In the description below, height designates any distance measured parallel to the axis A.

In the example illustrated, this drilling head 7 has a conical tip 8 and a helical groove 9 (single, or preferably double) extending from the tip 8 along a defined height.

The drilling head 7 is designed to allow one or more preliminary holes 10 to be formed in a crest 11 of a jawbone, with a view to fitting an implant intended to receive a prosthetic tooth.

More precisely, such a preliminary hole 10 is intended to be formed in an implant site 12 delimited by at least one (natural or artificial) existing boundary tooth 13. As in the example illustrated, the implant site 12 can be delimited on each side by a pair of boundary teeth 13, 14. In this case, the width of the implant site 12 (measured in a mesiodistal direction) is designated L, and the thickness of the implant site 12, measured in a buccolingual direction at the top of the bone crest 11, is designated E.

It will be noted that, when the implant site 12 is dimensioned to receive a single prosthetic tooth (as a replacement for a single lost tooth), the preliminary hole 10 must be made substantially at an equal distance from the boundary teeth 13, 14. By contrast, when the implant site 12 is dimensioned to receive several prosthetic teeth (as replacements for several lost teeth), the preliminary hole 10 has to be positioned with reference to the closest boundary tooth 13, or with reference to the preliminary hole 10 drilled previously, as is illustrated in FIG. 8.

The drilling head 7 has an (overall) external diameter D1, called the drilling diameter, of between 1.5 and 3 mm. According to a particular embodiment, the diameter D1 is of the order of 2 mm.

The tool 6 secondly comprises a mandrel 15 (cylindrical in the example shown) rigidly connected to the head 7 and coaxial therewith. This mandrel 15 is dimensioned (and configured) to be able to be mounted in the mandrel holder 5 of the contra-angle 4 in order to induce a rotational coupling of the drilling head 7 to the mandrel holder 5.

More precisely, and as will be seen from FIG. 2, the mandrel 15 has, at a distal end (opposite the head 7), a flat face 16 and a peripheral groove 17. The coupling of the mandrel 15 to the mandrel holder 5 is obtained by means of a key and an elastic hook (which are integrated in the mandrel holder 5) cooperating, respectively, with the flat face 16 and the groove 17.

The tool 6 thirdly comprises a mesiodistal guide cylinder 18, which is coaxial with the drilling head 7 (and therefore with the mandrel 15). This mesiodistal guide cylinder 18 has an external diameter D2, called the mesiodistal guide diameter, greater than the drilling diameter D1. The choice of the mesiodistal guide diameter D2 depends on the width L of the implant site 12. More precisely, the mesiodistal guide diameter D2 corresponds substantially to the width L when the site 12 is intended to receive a single prosthetic tooth, or to the width (measured in the mesiodistal direction) of a prosthetic tooth when the site 12 is intended to receive several prosthetic teeth.

In practice, the mesiodistal guide diameter D2 is preferably between 5 mm and 12 mm.

The mesiodistal guide cylinder 18 extends axially along a height H2 which is preferably between 1 mm and 20 mm, by which means it is possible to cover many oral configurations.

The tool 6 fourthly comprises a buccolingual guide cylinder 19 which is coaxial with the drilling head 7 (and therefore with the mandrel 15) and is situated under the mesiodistal guide cylinder 18. In other words, the mesiodistal guide cylinder 18 is superposed on the buccolingual guide cylinder 19.

The buccolingual guide cylinder 19 has an external diameter D3, called the buccolingual guide diameter, also greater than the drilling diameter D1 and preferably smaller than or equal to the mesiodistal guide diameter D2 (for the same tool 6).

The choice of the buccolingual guide diameter D3 depends on the thickness E of the implant site 12. More precisely, the buccolingual guide diameter D3 is equal or substantially equal to the diameter of the final bore intended to receive the implant, which itself has to be chosen to be equal to or less than the thickness E reduced by a safety margin of twice 2 mm, this safety margin corresponding to the minimal thickness of bone substance that has to remain on each side (in the buccolingual direction) of the final bore.

Thus:

D3(mm)=E(mm)−4

In practice, the buccolingual guide diameter D3 is preferably between 3 mm and 6 mm. Moreover, the buccolingual guide cylinder 19 has an axial height H3 which is preferably between 0.5 mm and 20 mm. This range of heights allows the practitioner to correctly visualize the buccolingual positioning of the tool 6, without the axial size (that is to say the total height) thereof being too great. This means that the patient does not have to open his mouth too wide during the intervention.

According to an embodiment illustrated in the figures, the tool 6 comprises a one-piece drill bit 20 forming the drilling head 7 and the mandrel 15, and the mesiodistal guide cylinder 18 and the buccolingual guide cylinder 19 are attached by being mounted on the drill bit 20. The drill bit 20 is made, for example, of surgical quality steel (generally a chromium, nickel and molybdenum alloy, for example the grade X2CrNiMo17-12 currently used), the head 7 being optionally covered with titanium nitride (TiN). Alternatively, the drill bit 20 can be made of ceramic or of titanium.

The cylinders 18, 19 themselves are preferably made of surgical steel, although they can be made of any other material compatible with dental implant surgery, for example titanium, stellite, zirconium oxide (ceramic), silicone, sterilizable polymer, etc. The cylinders 18, 19 could be rigidly connected to the drill bit 20 for conjoint translation and/or rotation therewith, for example by means of radial clamping screws, or they could be machined as a one-piece assembly together with the head 7 and the mandrel 15. In the latter case, a range of tools 6 has to be produced, including various combinations of diameters D2 and D3 and of heights H2 and H3 (for the same diameter D1).

However, according to a preferred embodiment, the cylinders 18, 19 are mounted with free translation and free rotation on the drill bit. For this purpose, the mesiodistal guide cylinder 18 is provided with a central bore 21 having a diameter that corresponds, allowing for play, to the external diameter D1 of the drill bit 20. Similarly, the buccolingual guide cylinder 19 is provided with a central bore 22 having a diameter that likewise corresponds, allowing for play, to the external diameter D1 of the drill bit 20.

Being mounted in a sliding manner, the cylinders 18, 19 maintain their position with respect to the patient's jaw while the head 7 of the drill bit 20 penetrates the bone crest 11, thereby enhancing the precision of the work.

As will be seen in the figures, and more particularly in FIGS. 2 and 4 through 7, the tool 6 can additionally comprise a depth stop 23 in the form of a ring rigidly connected to the mandrel 15 of the drill bit 20. The stop 23 is fixed (in rotation and in translation) on the mandrel 15 of the drill bit 20 by, for example, a radial set screw 24 (typically with a hexagon socket). It is in this case fixed adjustably, which allows the drilling depth to be modified. Care will be taken to maintain, between the depth stop 23 and the mesiodistal guide cylinder 18, a distance d corresponding to the drilling depth, in the configuration where the tip 8 is substantially coplanar with a lower end face 25 of the buccolingual guide cylinder 19 (as is illustrated in FIGS. 4 and 5), which corresponds to the start of the drilling.

This distance d defines the travel of the drill bit 20, that is to say the drilling depth, the drilling being terminated when the depth stop 23 comes to bear against an upper face 26 of the mesiodistal guide cylinder 18 (FIGS. 6 and 7).

The formation of a preliminary hole 10 in an implant site 12 defined between two boundary teeth 13, 14 for placement of a single implant is illustrated in FIGS. 3 to 7.

The practitioner begins by choosing the size (diameter D2, height H2) of the mesiodistal guide cylinder 18 according to the width L of the implant site 12.

The practitioner also chooses the size (diameter D3, height H3) of the buccolingual guide cylinder 19 according to the thickness E of the bone crest 11. More precisely, as we have seen, the diameter D3 is chosen with a value equal to the thickness E reduced by 4 millimeters.

The drill bit 20 is mounted on the contra-angle 4 by being coupled to the mandrel holder 5, then the cylinders 18, 19 are engaged on the drill bit 20, first the mesiodistal guide cylinder 18 and then the buccolingual guide cylinder 19. The depth stop 23 is adjusted according to the criteria defined above, so as to be distant from the mesiodistal guide cylinder 18 by the drilling depth.

The practitioner is then able to perform the drilling operation. It is possible for an incision to have been made beforehand in the patient's gum in the mesiodistal direction and for the gum flaps to have been spaced apart laterally in order to free the implant site 12 on the bone crest 11 thus exposed (for the sake of clarity, the gum has deliberately been omitted in the figures). However, it is possible to perform a surgical operation of this kind without flaps, that is to say by drilling directly through the gum.

The mesiodistal guide cylinder 18 ensures an indexing of the tip 8 in the mesiodistal direction. This indexing is obtained by simple insertion of the tool 6 into the implant site 12, the boundary teeth 13, 14 being in contact (or almost in contact) with the cylinder 18. It remains for the practitioner to correctly position the tool 6 in the buccolingual direction, which he is able to do by guesswork if experienced, or with the aid of a depth gauge allowing him to check that the buccolingual guide cylinder 19 is at the desired distance (presently 2 mm in current practice, as we have seen) from the edge of the bone crest 11.

The drilling can then be carried out by simply pressing on the tool 6, the head 7 then machining (FIGS. 6 and 7) a bore 10 in the bone crest 11 to a depth equal to the travel defined by the distance d of the depth stop 23 from the mesiodistal guide cylinder 18, which distance has been set in advance as indicated above.

It will thus be seen that the cylinders 18, 19 provide mesiodistal guiding and buccolingual guiding at the same time. This two-fold guiding enhances the precision of the intervention and the safety of the patient. The risk of the operation being unsuccessful is reduced.

It will be noted that the cylinders 18, 19, when mounted slidably on the drill bit 20, also contribute to the axial guiding of the latter, which limits the risk of the tool 6 tilting during drilling and further enhances the precision (and therefore the chances of success) of the intervention.

As will be seen in FIG. 8, the tool 6 that has just been described can be used to drill multiple holes in an implant site 12, corresponding to several missing teeth (two in the example shown).

A first step involves using the tool 6 described above to drill a first hole 10 near a first boundary tooth 13.

In a second step, a false-tooth model 27 is placed temporarily in the bore that has been formed, said model 27 having a tooth shape or a cylinder 28 (with a diameter corresponding to the mesiodistal extent of the false tooth to be fitted) and a stem 29 with a diameter corresponding to the diameter of the preliminary hole 10, or with a diameter slightly greater in order to increase the stability of the model 27. The model 27 is fitted in place simply by introducing the stem 29 into the preliminary hole 10.

In a third step, a second preliminary hole (indicated by broken lines in FIG. 8) is drilled in the manner previously described using the model 27 thus fitted. When the patient has lost all teeth starting from the boundary tooth 13, the mesiodistal guiding is unilateral. In the presence of a second boundary tooth 14, the latter permits bilateral guiding.

By virtue of its ease of use and precision, the tool 6 described above is particularly suitable for this multiple drilling technique.

A number of variants are conceivable.

In particular, at least the mesiodistal guide cylinder 18 (and optionally the buccolingual guide cylinder 19) could be made at least partially from a transparent or translucent material so as to transmit the light issuing from a lighting unit mounted on the contra-angle 4, in such a way as to illuminate the implant site 12 and thus make the buccolingual guiding easier.

In practice, the mesiodistal guide cylinder 18 can comprise a tubular steel sleeve to allow it to be mounted on the drill bit 20 around which is molded a cylindrical body made of transparent or translucent (advantageously biocompatible) plastic material.

Moreover, provision can conceivably be made that one of the cylinders 18, 19 is rigidly connected to the drilling head 7 (for example by being formed integrally therewith), the other cylinder being free in rotation and/or in translation. Thus, the mesiodistal guide cylinder 18 could be rigidly connected to the head 7, with the buccolingual guide cylinder 19 being free.

At least one of the cylinders 18, 19 could also be provided with (helical or straight) irrigation channels which have the function of channeling a heat-exchange fluid (typically physiological saline) toward the implant site 12 in order to cool the bone and the drill bit 20, which have a tendency to grow hot during the drilling.

1. A drilling tool for dental implant surgery, this tool comprising:
a drilling head, which extends along a main axis (A), this drilling head having an external diameter (D1) called the drilling diameter;
a mandrel rigidly connected to the head and coaxial therewith, this mandrel being able to be mounted in a mandrel holder in order to induce a rotational coupling of the drilling head to this mandrel holder;
a mesiodistal guide cylinder coaxial with the drilling head, this mesiodistal guide cylinder having an external diameter (D2), called the mesiodistal guide diameter, greater than the drilling diameter (D1); and
a buccolingual guide cylinder coaxial with the drilling head and situated under the mesiodistal guide cylinder, this buccolingual guide cylinder having an external diameter (D3), called the buccolingual guide diameter, greater than the drilling diameter (D1) and smaller than the mesiodistal guide diameter (D2).

2. The tool as claimed in claim 1, wherein it comprises a one-piece drill bit forming the drilling head and the mandrel, and in that the mesiodistal guide cylinder and the buccolingual guide cylinder are attached by being mounted on the drill bit.

3. The tool as claimed in claim 2, wherein each cylinder is provided with a central bore for mounting it with free rotation on the drill bit.

4. The tool as claimed in claim 3, wherein it comprises a depth stop in the form of a ring rigidly connected to the mandrel.

5. The tool as claimed in claim 1, wherein at least one of the cylinders is rigidly connected to the mandrel or to the drilling head.

6. The tool as claimed in claim 1, wherein the mesiodistal guide diameter (D2) is between 5 mm and 12 mm.

7. The tool as claimed in claim 1, wherein the buccolingual guide diameter (D3) is between 3 mm and 6 mm.

8. The tool as claimed in claim 1, wherein the mesiodistal guide cylinder has a height (H2) of between 0.5 mm and 20 mm.

9. The tool as claimed in claim 1, wherein the buccolingual guide cylinder has a height (H3) of between 0.5 mm and 20 mm.

10. The tool as claimed in claim 1, wherein at least one of the cylinders is provided with irrigation channels.
